(19) United States
(12) Patent Application Publication
(10) Pub. No.: US 2005/0281465 A1
(43) Pub. Date: Dec. 22, 2005

(54) Method and apparatus for computer assistance with total hip replacement procedure

(76) Inventors: Joel Marquart, Davie, FL (US); Marwan Sati, Mississauga (CA); Peter Tate, Georgetown (CA); Louis K. Arata, Mentor, OH (US); Randall Hand, Pembroke Pines, FL (US); Arthur E. Quaid III, Hollywood, FL (US); Rony A. Abovitz, Hollywood, FL (US); Ryan C. Lakin, Newton, NJ (US)

Correspondence Address: MUNSCH, HARDT, KOPF & HARR, P.C., INTELLECTUAL PROPERTY DOCKET CLERK, 1445 ROSS AVENUE, SUITE 4000, DALLAS, TX, 75202-2790, US

(21) Appl. No.: 11/006,459

(22) Filed: Dec. 6, 2004

Related U.S. Application Data
(63) Continuation of application No. 10/772,092, filed on Feb. 4, 2004.

(51) Int. Cl. G06K 9/46

(52) U.S. Cl. 382/195

(57) ABSTRACT

Hip replacement surgery involves replacing the head and neck of the femur with an artificial component having a ball-shaped head and neck similar to that of a replaced femoral head and neck and inserting a cup-shaped component into the acetabulum to act as a liner to receive the ball of the femoral component. During this procedure, a surgeon encounters or has to overcome several problems. These problems include establishing the correct inclination, version and medialization for the acetabular component of the artificial hip; the correct version or angle of the femoral component; and maintaining correct leg length.

This patent application is a continuation of U.S. patent application Ser. No. 10/772,092, entitled “Method and Apparatus for Computer Assistance with Total Hip Replacement Procedure,” filed Feb. 4, 2004; and claims the benefit of U.S. provisional patent application Ser. No. 60/445,002, entitled “Method and Apparatus for Computer Assistance with Total Hip Replacement Procedure”, filed Feb. 4, 2003, the disclosure of which is incorporated herein by reference. This application relates to the following U.S. provisional patent applications: Ser. No. 60/444,824, entitled “Interactive Computer-Assisted Surgery System and Method”; Ser. No. 60/444,975, entitled “System and Method for Providing Computer Assistance With Spinal Fixation Procedures”; Ser. No. 60/445,078, entitled “Computer-Assisted Knee Replacement Apparatus and Method”; Ser. No. 60/444,989, entitled “Computer-Assisted External Fixation Apparatus and Method”; Ser. No. 60/444,988, entitled “Computer-Assisted Knee Replacement Apparatus and Method”; Ser. No. 60/445,001, entitled “Method and Apparatus for Computer Assistance With Intramedullary Nail Procedure”; and Ser. No. 60/319,924, entitled “Portable, Low-Profile Integrated Computer, Screen and Keyboard for Computer Surgery Applications”; each of which was filed on Feb. 4, 2003 and is incorporated herein by reference. This application also relates to the following applications: U.S. patent application Ser. No. 10/772,083, entitled “Interactive Computer-Assisted Surgery System and Method”; U.S. patent application Ser. No. 10/771,850, entitled “System and Method for Providing Computer Assistance With Spinal Fixation Procedures”; U.S. patent application Ser. No. 10/772,139, entitled “Computer-Assisted Knee Replacement Apparatus and Method”; U.S. patent application Ser. No. 10/772,142, entitled Computer-Assisted External Fixation Apparatus and Method”; U.S. patent application Ser. No. 10/772,085, entitled “Computer-Assisted Knee Replacement Apparatus and Method”; U.S. patent application Ser. No. 10/771,851, entitled “Method and Apparatus for Computer Assistance With Intramedullary Nail Procedure”; and U.S. patent application Ser. No. 10/772,137, entitled “Portable Low-Profile Integrated Computer, Screen and Keyboard for Computer Surgery Applications”; each of which was filed on Feb. 4, 2004 and is incorporated herein by reference.

### TECHNICAL FIELD OF THE INVENTION

The present invention relates generally to computer assisted surgery systems and surgical navigation systems.

### BACKGROUND OF THE INVENTION

Image-based surgical navigation systems display the positions of surgical tools with respect to preoperative (prior to surgery) or intraoperative (during surgery) image data sets. Two and three dimensional image data sets are used, as well as time-variant images data (i.e. multiple data sets taken at different times). Types of data sets that are primarily used include two-dimensional fluoroscopic images and three-dimensional data sets include magnetic resonance imaging (MRI) scans, computed tomography (CT) scans, positron emission tomography (PET) scans, and angiographic data. Intraoperative images are typically fluoroscopic, as a C-arm fluoroscope is relatively easily positioned with respect to a patient and does not require that a patient be moved. Other types of imaging modalities require extensive patient movement and thus are typically used only for preoperative and post-operative imaging.

The most popular navigation systems make use of a tracking or localizing system to track tools, instruments and patients during surgery. These systems locate in predefined coordinate space specially recognizable markers that are attached or affixed to, or possibly inherently a part of, an object such as an instrument or a patient. Markers can take several forms, including those that can be located using optical (or visual), electromagnetic, radio or acoustic methods. Furthermore, at least in the case of optical or visual systems, location of an object's position may be based on intrinsic features or landmarks that, in effect, function as recognizable markers. Markers will have a known, geometrical relationship with respect to, typically, an end point and/or axis of the instrument. Thus, objects can be recognized (identified) at least in part from the geometry of the markers, assuming that the that the geometry is unique. Once the tool is identified, the orientation of the axis and location of endpoint within a frame of reference is then deduced from the positions of the markers based on the known relationship.

Present-day tracking systems are typically optical, functioning primarily in the infrared range. They usually include a stationary stereo camera pair that is focused around the area of interest and sensitive to infrared radiation. Markers emit infrared radiation, either actively or passively. An example of an active marker is a light-emitting diodes (LEDs). An example of a passive marker is a reflective marker, such as ball-shaped marker with a surface that reflects incident infrared radiation. Passive systems require a an infrared radiation source to illuminate the area of focus. A magnetic system may have a stationary field generator that emits a magnetic field that is sensed by small coils integrated into the tracked tools.

Most CAS systems are capable of continuously tracking, in effect, the position of tools (sometimes also called instruments). With knowledge of the position of the relationship between the tool and the patient and the patient and an image data sets, a system is able to continually superimpose a representation of the tool on the image in the same relationship to the anatomy in the image as the relationship of the actual tool to the patient's anatomy. To obtain these relationships, the coordinate system of the image data set must be registered to the relevant anatomy of the actual patient portions of the of the patient's anatomy in the coordinate system of the tracking system. There are several known registration methods.

In CAS systems that are capable of using two-dimensional image data sets, multiple images are usually taken from different angles and registered to each other so that a representation of the tool or other object (which can be real or virtual) can be, in effect, projected into each image. As the position of the object changes in three dimensional space, its projection into each image is simultaneously updated. In order to register two or more two-dimensional data images together, the images are acquired with what is called a registration phantom in the field of view of the image device. In the case of a two dimensional fluoroscopic images, the phantom is a radio-translucent body holding radio-opaque fiducials having a known geometric relationship. Knowing the actual position of the fiducials in three dimensional space when each of the images are taken permits determination of a relationship between the position of the fiducials and their respective shadows in each of the images. This relationship can then be used to create a transform for mapping between points in three-dimensional space and each of the images. By knowing the positions of the fiducials with respect to the tracking system's frame of reference, the relative positions of tracked tools with respect to the patient's anatomy can be accurately indicated in each of the images, presuming the patient does not move after the image is acquired, or that the relevant are portions of the patient's anatomy is are tracked. A more detailed explanation of registration of fluoroscopic images and coordination of representations of objects in patient space superimposed in the images is found in U.S. Pat. No. 6,198,794 of Peshkin, et al., entitled “Apparatus and method for planning a stereotactic surgical procedure using coordinated fluoroscopy.”

### SUMMARY OF THE INVENTION

The invention is generally directed to improved computer-implemented methods and apparatus for further reducing the invasiveness of surgical procedures, eliminating or reducing the need for external fixtures in certain surgical procedures, and/or improving the precision and/or consistency of surgical procedures. The invention finds particular advantage in orthopedic procedures involving implantation of devices, though it may also be used in connection with other types of surgical procedures.

For example, hip replacement surgery involves replacing the head and neck of the femur with an artificial component having a ball-shaped head and neck similar to that of a replaced femoral head and neck and inserting a cup-shaped component into the acetabulum to act as a liner to receive the ball of the femoral component. During this procedure, a surgeon encounters or has to overcome several problems. These problems include establishing the correct inclination, version and medialization for the acetabular component of the artificial hip; the correct version or angle of the femoral component; and maintaining correct leg length.

To address one or more of these problems, various aspects of a specially programmed computer-assisted surgery system assist the surgeon in calculating this information and providing feedback to the surgeon during the procedure. With this information and feedback, one or more of the following are possible: less need for guides, smaller incisions, less damage, and a more predictable and consistent outcome. A preferred embodiment of an example of an application for programming a computer-assisted surgery system is described below.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 is a block diagram of an exemplary computer-assisted surgery system;

FIG. 2 is a flow chart of basic stages of an application program for assisting with or guiding the planning of a surgical procedure and navigation during the procedure.

FIGS. 3A and 3B are flow charts of basic steps of a process for guiding the planning and execution of a hip replacement procedure.

FIGS. 4-17 are representative screens of graphical user interface pages displayed by the computer-assisted surgery system of FIG. 1 during use of the application of FIG. 4.

### DETAILED DESCRIPTION OF THE DRAWINGS

In the following description, like numbers refer to like elements. References to “surgeon” include any user of a computer-assisted surgical system, a surgeon being typically a primary user.

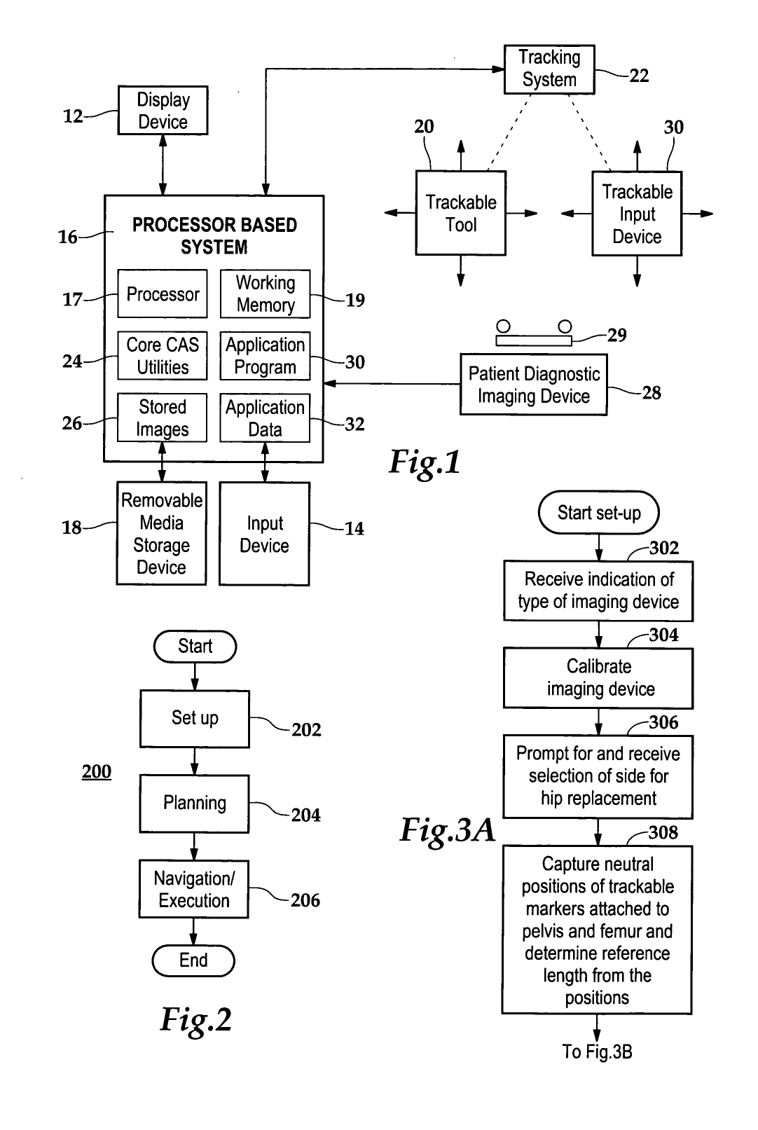

FIG. 1 is a block diagram of an exemplary computer-assisted surgery (CAS) system 10. Computer-assisted surgery system (CAS) 10 comprises a display device 12, an input device 14, and a processor-based system 16, for example, a computer. Display device 12 may be any display device now known or later developed for displaying two-dimensional and/or three-dimensional diagnostic images, for example, a monitor, a touch screen, a wearable display, a projection display, a head-mounted display, stereoscopic views, a holographic display, a display device capable of displaying image(s) projected from an image-projecting device, for example a projector, and/or the like. Input device 14 may be any input device now known or later developed, for example, a keyboard, a mouse, a trackball, a trackable probe and/or the like. The processor-based system is preferably programmable and includes one or more processors 16a, working memory 16b for temporary program and data storage that will be used primarily by the processor, and storage for programs and data, preferably persistent, such as a disk drive. Removable media storage device 18 can also be used to store programs and/or transfer to or from the transfer programs.

Tracking system 22 continuously determines, or tracks, the position of one or more trackable markers disposed on, incorporated into, or inherently a part of surgical tools or instruments 20 with respect to a three-dimensional coordinate frame of reference. With information from the tracking system on the location of the trackable markers, CAS system 10 is programmed to be able to determine the three-dimensional coordinates of an endpoint or tip of a tool and, optionally, its primary axis using predefined or known (e.g. from calibration) geometrical relationships between trackable markers on the tool and the end point and/or axis of the tool. A patient, or portions of the patient's anatomy, can also be tracked by attachment of arrays of trackable markers.

The CAS system can be used for both planning surgical procedures (including planning during surgery) and for navigation. It is therefore preferably programmed with software for providing basic image-guided surgery functions, including those necessary in determining the position of the tip and axis of instruments and for registering a patient and preoperative and/or intraoperative diagnostic image data sets to the coordinate system of the tracking system. The programmed instructions for these functions are indicated as core CAS utilities 24. These capabilities allow the relationship of a tracked instrument to a patient to be displayed and constantly updated in real time by the CAS system overlaying a representation of the tracked instrument on or more graphical images of the patient's internal anatomy on display device 12. The graphical images are constructed from one or more stored image data sets 26 acquired from diagnostic imaging device 28. Thee imaging device may be a fluoroscope, such as a C-arm fluoroscope, capable of being positioned around a patient lying on an operating table. It may also be a MR, CT or other type of imaging device in the room or permanently located elsewhere. Where more than one image is shown, as when multiple fluoroscopic images are simultaneously displayed of display device 12, the representation of the tracked instrument or tool is coordinated between the different images. However, the CAS system can be used in some procedures without the diagnostic image data sets, with only the patient being registered. Thus, the CAS system not need to support the use of diagnostic images in some applications—i.e. an imageless application.

Furthermore, as disclosed herein, the CAS system may be used to run application-specific programs 30 that are directed to assisting a surgeon with planning and/or navigation during specific types of procedures. For example, the application programs may display predefined pages or images corresponding to specific steps or stages of a surgical procedure. At a particular stage or part of a program, a surgeon may be automatically prompted to perform certain tasks or to define or enter specific data that will permit, for example, the program to determine and display appropriate placement and alignment of instrumentation or implants or provide feedback to the surgeon. Other pages may be set up to display diagnostic images for navigation and to provide certain data that is calculated by the system for feedback to the surgeon. Instead of or in addition to using visual means, the CAS system could also communicate information in ways, including using audibly (e.g. using voice synthesis) and tactilely, such as by using a haptic interface of device. For example, in addition to indicating visually a trajectory for a drill or saw on the screen, a CAS system may feedback to a surgeon information whether he is nearing some object or is on course with a audible sound or by application of a force or other tactile sensation to the surgeon's hand.

To further reduce the burden on the surgeon, the program may automatically detect the stage of the procedure by recognizing the instrument picked up by a surgeon and move immediately to the part of the program in which that tool is used. Application data 32—data generated or used by the application—may also be stored processor-based system.

Various types of user input methods can be used to improve ease of use of the CAS system during surgery. One example is the use of speech recognition to permit a doctor to speak a command. Another example is the use of a tracked object to sense a gesture by a surgeon, which is interpreted as an input to the CAS system. The meaning of the gesture could further depend on the state of the CAS system or the current step in an application process executing on the CAS system. Again, as an example, a gesture may instruct the CAS system to capture the current position of the object. One way of detecting a gesture is to occlude temporarily one or more of the trackable markers on the tracked object (e.g. a probe) for a period of time, causing loss of the CAS system's ability to track the object. A temporary visual occlusion of a certain length (or within a certain range of time), coupled with the tracked object being in the same position before the occlusion and after the occlusion, would be interpreted as an input gesture. A visual or audible indicator that a gesture has been recognized could be used to provide feedback to the surgeon.

Yet another example of such an input method is the use of tracking system 22 in combination with one or more trackable data input devices 34. Defined with respect to the trackable input device 34 are one or more defined input areas, which can be two-dimensional or three-dimensional. These defined input areas are visually indicated on the trackable input device so that a surgeon can see them. For example, the input areas may be visually defined on an object by representations of buttons, numbers, letters, words, slides and/or other conventional input devices. The geometric relationship between each defined input area and the trackable input device is known and stored in processor-based system 16. Thus, the processor can determine when another trackable object touches or is in close proximity a defined input area and recognize it as an indication of a user input to the processor-based systems. For example, when a tip of a tracked pointer is brought into close proximity to one of the defined input areas, the processor-based system will recognize the tool near a the defined input area and treat it as a user input associated with that defined input area. Preferably, representations on the trackable user input correspond user input selections (e.g. buttons) on a graphical user interface on display device 12. The trackable input device may be formed on the surface of any type of trackable device, including devices used for other purposes. In a preferred embodiment, representations of user input functions for graphical user interface are visually defined on a rear, flat surface of a base of a tool calibrator.

Processor-based system 16 is, in one example, a programmable computer that is programmed to execute only when single-use or multiple-use software is loaded from, for example, removable media. The software would include, for example the application program 30 for use with a specific type of procedure. Media storing the application program can be sold bundled with disposable instruments specifically intended for the procedure. The application program would be loaded into the processor-based system and stored there for use during one (or a defined number) of procedures before being disabled. Thus, the application program need not be distributed with the CAS system. Furthermore, application programs can be designed to work with specific tools and implants and distributed with those tools and implants. Preferably, also, the most current core CAS utilities may also be stored with the application program. If the core CAS utilities on the processor-based system are outdated, they can be replaced with the most current utilities.

Referring now to FIG. 2, the CAS system assists a surgeon in performing a total hip replacement procedure by executing a process 200 that has three basic phases: set-up phase 202, planning phase 204 and navigation phase 206. The set-up phase involves the surgeon specifying to the process what implants, tools and fluoroscope will be used during the process, as well as certain options. The planning phase involves the surgeon defining for the process the location of certain landmarks, either with reference to diagnostic images taken of the patient or directly to the patient's anatomy. These landmarks are used to establish a reference. The navigation or execution stage tracks the surgeon's instruments and provides alignment information and feedback on various angles and dimensions during the procedure.

Process 200, or parts thereof, preferably display a series of pages corresponding to stages or sub-procedures, each page being set up to display directions and information (including images) relevant to the stage of the procedure. In addition to, or in place of, a visual presentation of some or all of the information, the process may operate on the CAS system to communicate information to the surgeon in a manner other than visually, such as by audibly (speech or sound) or haptically.

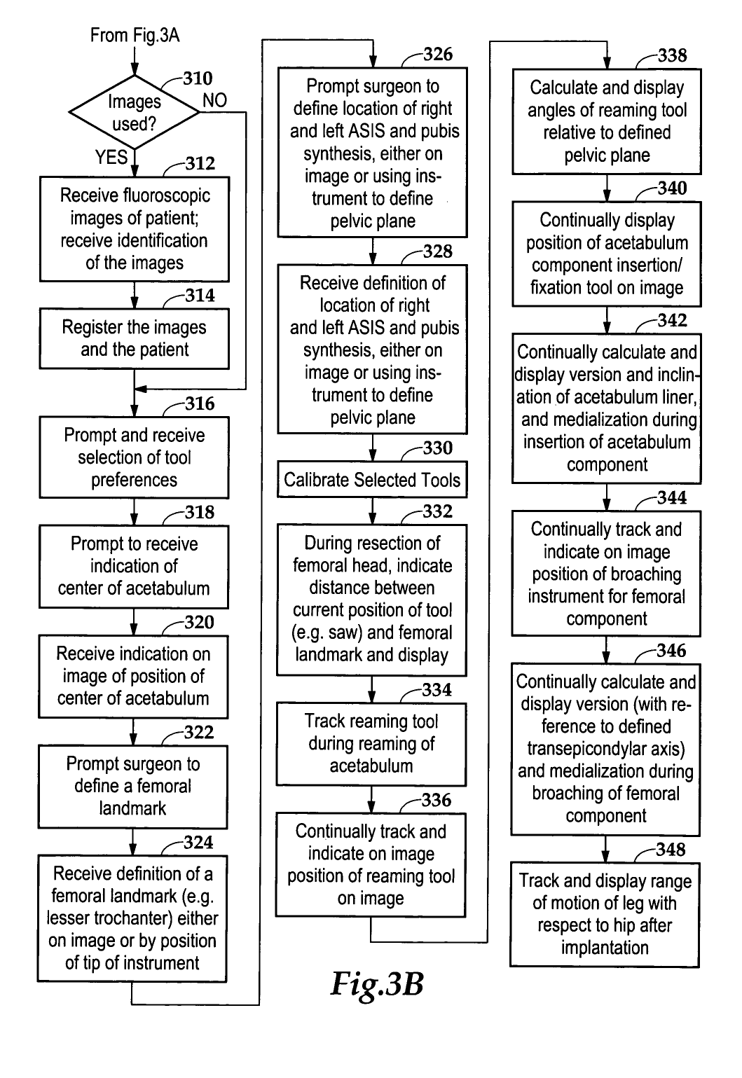

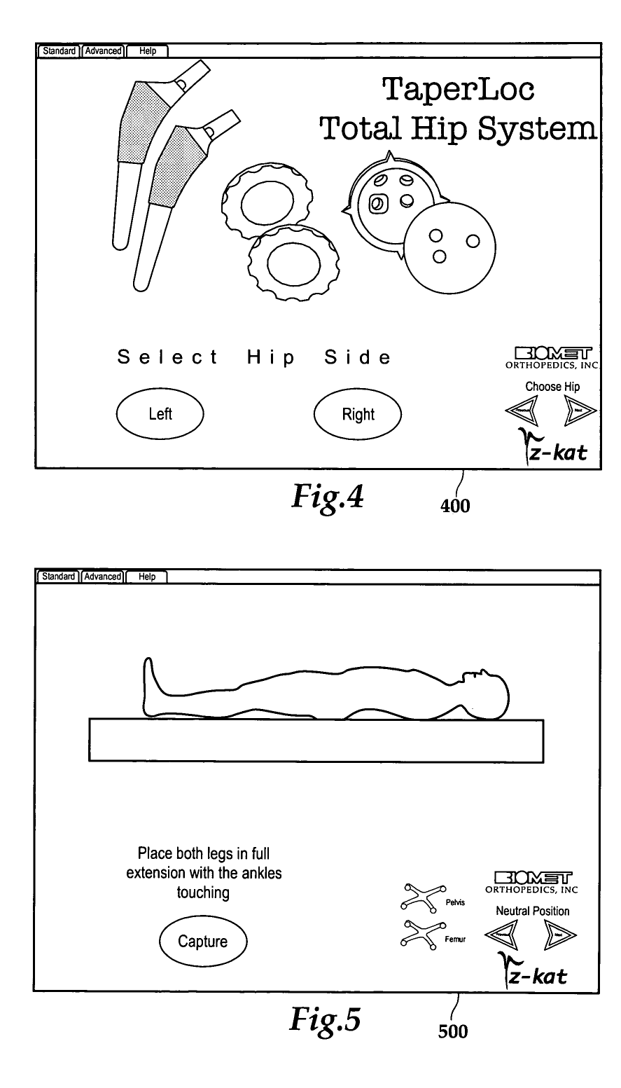

Although the process may constrain what a surgeon does in terms of the ordering of certain steps, the process preferably follows the surgeon, rather than requiring the surgeon to follow the process. This is particularly useful during the planning and navigation or execution phases of the process, where the surgeon may need to go back and change a plan or repeat steps. Thus, in the following explanation of process 200, some steps may be performed out of sequence or repeated. The surgeon may indicate to the process the stage he or she is in or wants to go to. This may be done through user input or by the process automatically recognizing when the surgeon has either finished a stage or is preparing to go to another stage (not necessarily the next stage) by, for example, the surgeon picking up an instrument used in a particular stage. Once the system recognizes the particular tool, the system will automatically move to the particular step where the tool is used. Details of the process 200 will be described with reference to the flow charts of FIGS. 3A and 3B and representative examples of screens from such pages, shown in FIGS. 4-17. The pages may contemplate use of artificial hips for a specific vendor. However, the process and concepts embodied or represented by the pages are not limited to any specific vendor, and aspects thereof may be employed in connection with surgical planning and guidance systems for similar types of implants. Furthermore, some or all of the information contained in the screens, except for the actual diagnostic images of the patient, may be communicated in ways other than visually, such as by voice, sound or haptically.

Referring now to FIG. 3A and FIGS. 4-8, the process prompts the surgeon at step 302 to identify the type of imaging device, for example, which type of C-arm fluoroscope will be used, and the process calibrates it at step 304 according to known methods. For example, it is well known, for example, that fluoroscopic images are inherently distorted and must be dewarped in order to be calibrated. One common approach to dewarping is the use of a calibration grid. Although none of the figures show such a grid, if such a grid was used, the process would display an image with the calibration grid, with which a calibration factor for the particular imaging device is derived.

Although the use a fluoroscopic images has certain advantages, other types of images can be used in place of, or in addition to, the fluoroscopic images, including without limitation preoperative three-dimensional data sets such as CT and MRI scans. The surgeon is prompted at step 306 to specify which hip will be replaced. FIG. 4 is a representative page 400 that is displayed at this step. At step 308, the positions of trackable markers that are attached to the patient's pelvis and femur are captured when the patient is in a neutral position. The screen 500 shown in FIG. 5 is an example of a page that can be used to prompt the surgeon to capture the positions of the markers when the patient is in the neural position. Once the process receives this information, it calculates a reference length based on the positions of the trackable markers.

The process may be used without diagnostic images of the patient. Advantages to using images include reducing invasiveness, higher accuracy and better planning ability. As indicated by decision step 310, image acquisition and registrations steps 312 and 314 are performed if imaging is selected. Using a page on the CAS system display such as the one shown in FIG. 6, the process directs the surgeon to acquire certain images at step 312. The surgeon positions the fluoroscope in the pose necessary to acquire one of the listed images. It appears in window 602 and, if acceptable, it is stored and shown in window 604. Before storing the image, the surgeon identifies the image. In this example, he selects one of the icons 608 on the patient illustration 606. The patient illustration is an anterior view of the patient's pelvis and femur and a lateral view of the patient's pelvis and femur. The preferred images are anterior/posterior (A/P) images of the left and right ASIS (Anterior Superior Iliac Spine), pubis synthesis and hip that is being replaced, lateral images of the side where the hip is being replaced of the hip an, ASIS and the hip, and a medial lateral image of the knee on the side of the replacement hip. The surgeon may elect not to acquire all of the suggested images.

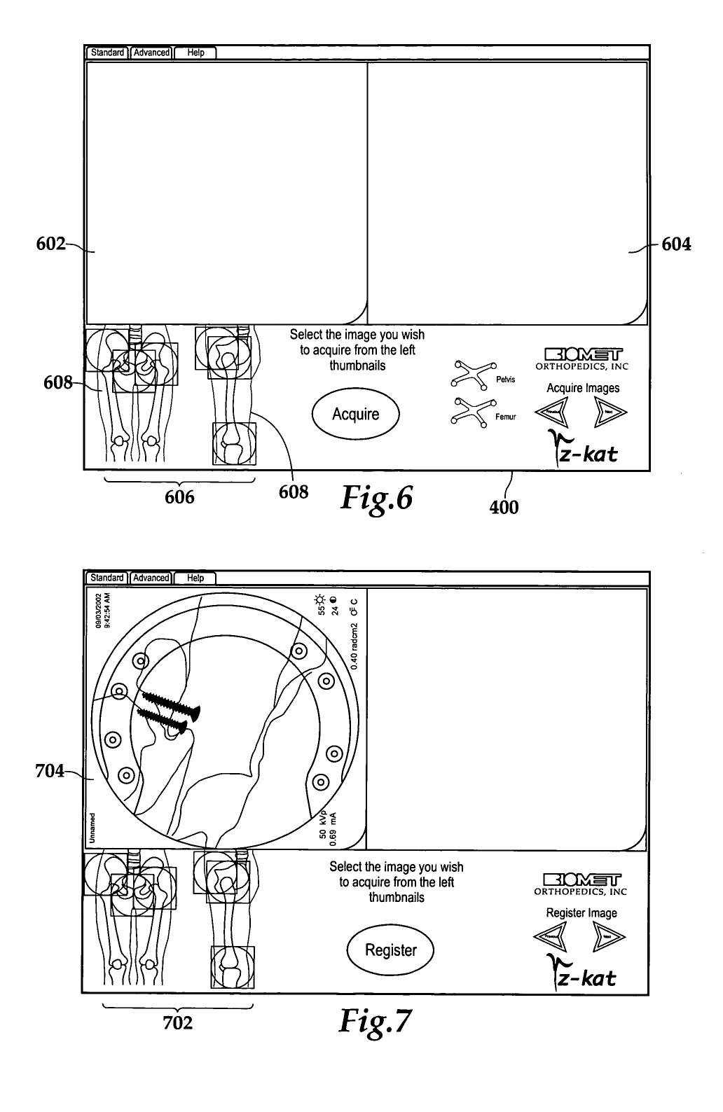

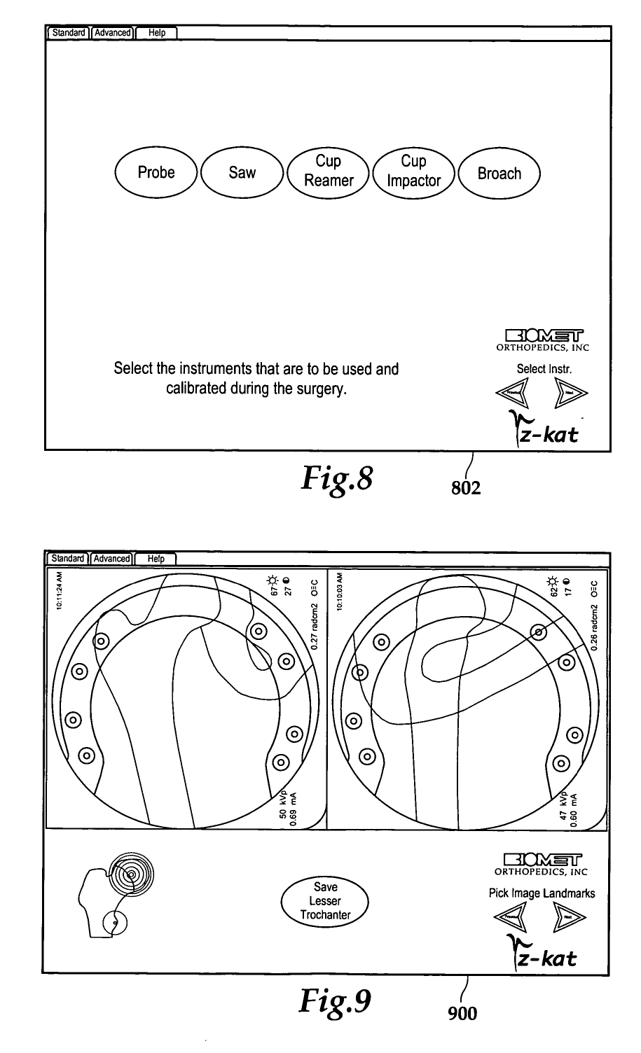

Each of the stored images is then registered by the CAS system at step 312. FIG. 7 is an example of a page displayed to the surgeon for directing the surgeon to select stored images for registration and registering them. The surgeon selects the stored image, in this example using patient illustration 702, which will be registered. The selected stored image is shown in window 704. At step 316 the surgeon is then directed to specify application-specific tools that he will use during the procedure that can be or will be tracked. FIG. 8 is a representative tool selection screen 802. Surgeons may prefer to use different tools for a given step, and this step permits the surgeon to select the tool of choice so that the CAS system can properly track it. The application may display a different page at a given step, display pages in a different order, based on selection of the tool, or make different assumptions for tracking an instrument. Furthermore, a surgeon may, for example, elect not to use a tool or not have it tracked. The process will adjust as necessary to accommodate the preferences to avoid forcing a surgeon to find ways to bypass steps or alter presentation of the pages. The CAS system is typically programmed or set up to operate with a probe and other basic tools that a surgeon may use.

Referring now to FIG. 3B, the process then asks the surgeon to identify certain landmarks with respect to the images, if acquired, and then receives and stores the three-dimensional coordinates of these landmarks. The surgeon may also point to the actual landmarks using a tracked probe, for example, and signal the CAS system to capture the point of the probe. This takes place during steps 318 to 328. The landmarks preferably include the center of the acetabulum, a femoral landmark (e.g. the lesser trochanter), pubic synthesis and left and right ASIS. The femoral landmark is used as a reference point during removal of the head of the femur. The public synthesis and left and right ASIS define the pelvic plane, which is used for determining several angles.

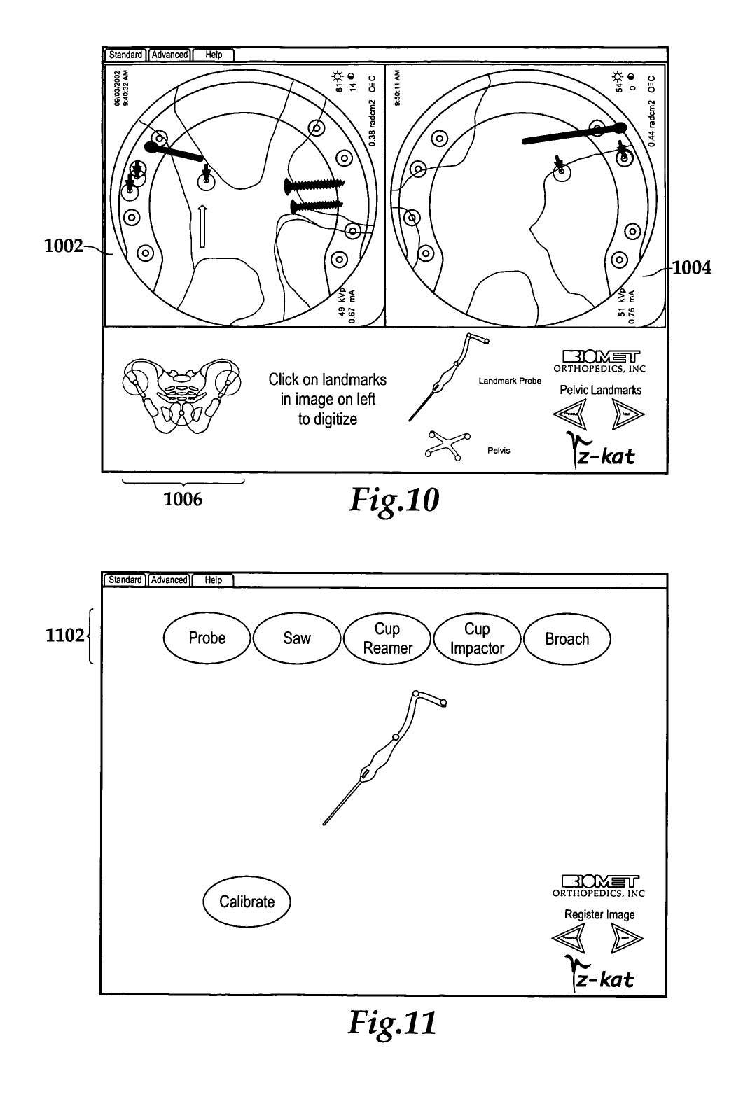

No exemplary page for identifying the center of the acetabulum at steps 318 and 320 is included in the figures. To identify the center of the acetabulum, it is preferable to display an A/P and a lateral image of the hip and a marker on the images for the surgeon to move to the correct position. The marker is preferably a projection into each image of a spherical object roughly the same diameter as the femoral head, or a series of concentrically arranged spheres of different diameters. FIG. 9 is a representative example of a page 900 displayed for registration of the lesser trochanter. The A/P and lateral images 902 and 904 of the hip are displayed for the surgeon to mark the landmarks. FIG. 10 is a representative example of a page displayed for prompting and receiving from the surgeon identification of the two ASIS and the pubis synthesis. The stored A/P and lateral screen images 1002 and 1004 of the anatomical area in which each landmark is located are displayed. The surgeon may then indicate on the images the position of each landmark for capture and storage. The landmarks are marked on a graphical illustration of the anatomy in area 1006 of the screen. The surgeon selects which landmarks he wants to identify by selecting the landmark marked on the graphical illustration.

The navigation/execution stage of the process begins at step 332. The basic steps of the hip replacement surgery involve resection of the femoral head, reaming of acetabulum, insertion of the acetabular component into the acetabulum, preparing the canal of the femur using a broach to accept the step of the femoral component, and inserting of the femoral component into the proximal end of the femur. These steps are well known and may differ slightly depending on the particular artificial hip that is used and the preferences of the surgeon.

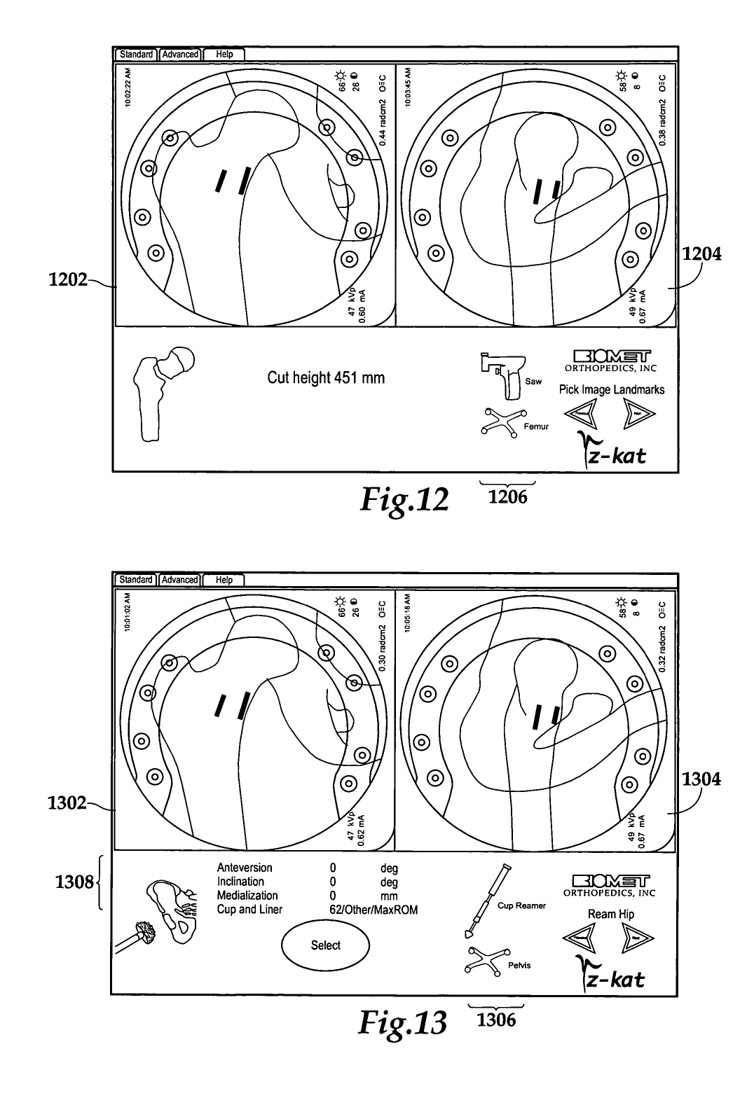

At step 332 a screen or page like the one shown in FIG. 12 is displayed by the process on the CAS system. It includes the stored A/P image 1202 and lateral image 1204. Although not shown in FIG. 12, the position of the axis and tip of a saw used for cutting the femoral head is continuously displayed with respect to the images. The cut height in terms of distance from the femoral landmark that the surgeon previously defined, which is preferably the lesser trochanter, may also be displayed. This distance can help to guide the surgeon, in addition to the images, during resection of the femoral head. If no images were acquired or registered by the surgeon for the hip, the distance could still be calculated, presuming the surgeon identified the landmark to the process by pointing to the landmark on the patient. The process may be programmed to automatically proceed to this step and (optionally) page when the cutting tool is brought into the field of view, as it is unique to the step and the CAS system must be able to recognize it by its trackable marker configuration in order to properly indicate its position on the diagnostic images.

In any step involving tracking of one or more trackable elements (e.g. tool or array), a graphical image of each element is displayed as well as an indication of whether the tracking system is actually tracking it. Examples of these graphical elements are shown in areas 1206 of FIGS. 12 and 1306 of FIG. 13, but preferably they are included on each page that involves tracking of an element.

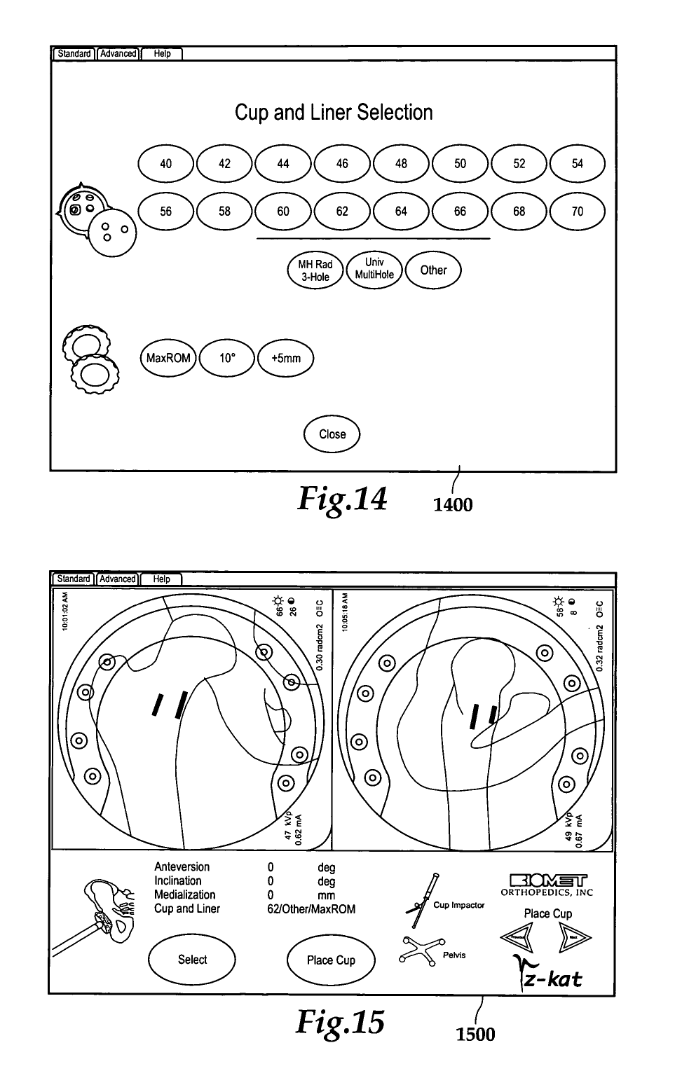

Steps 334 to 344 are taken during the stage in the surgery involving preparing the acetabulum by reaming it and fixing the acetabulum component. FIG. 13 is a representative screen of a page displayed during this process. As suggested by steps 334 and 336, the reaming tool is tracked and displayed with respect to the stored A/P and lateral images 1302 and 1304 of the hip. The marker array that is attached to the hip is also being continuously tracked. If the hip moves during the procedure, the movement is compensated for when displaying the position of the tool with respect to the images. At step 336 certain angles of the reaming tool relative to the predefined pelvic plane are continuously calculated and, preferably, displayed. These angles are version and inclination. Furthermore, medialization is also calculated and displayed. However, in order to calculate medialization, the type and size of the acetabular-component must be specified. FIG. 14 is a representative page 1400 listing types of cups and liners, the two parts to the acetabular component, which are available.

Once reaming is finished, the acetabulum component is inserted and fixed to the acetabulum. As indicated by steps 340 and 342, an insertion tool (e.g. a cup impactor) is continuously tracked. Preferably, the position of the cup with respect to the A/P and lateral images of the hip are continuously displayed along with information on version, inclination and medialization. FIG. 15 is an example of a page 1500 displayed by the CAS system at these steps. It is similar to FIG. 13, with the stored A/P image of the hip displayed in window 1502 and the stored lateral image of the hip displayed in window 1504, and the version, inclination, and medialization information indicated in area 1506. The surgeon may also select a different cup and liner by hitting the “select” button and be taken to a page such as the one of FIG. 14. The cup is then attached to the appropriate tool, and placed into the acetabulum. The system tracks the tool and enables the surgeon to place the cup in the exact orientation as desired. The process preferably jumps to these steps and displays this page in response to the surgeon brining the insertion tool into the field of focus of the CAS system.

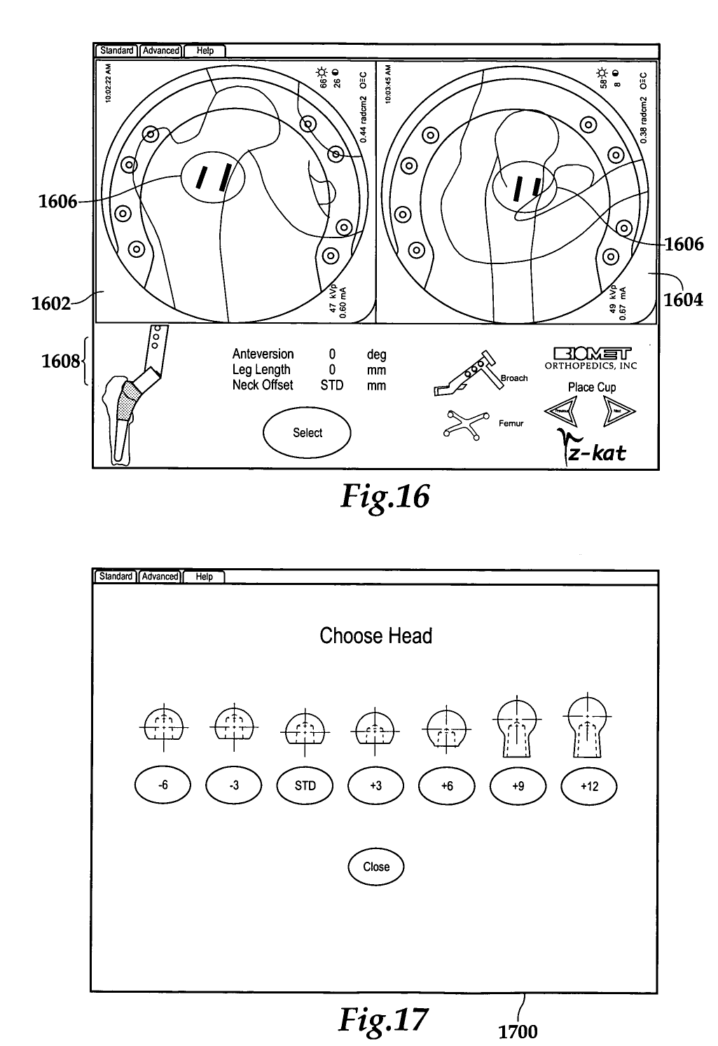

The process assists a surgeon during resection of the femoral head and broaching the femur canal by providing image guidance and information on the geometry by calculating and providing information on version, medialization or reference pre-operative leg-length difference and neck offset of the femoral component of the artificial hip. A page such as the page shown in FIG. 16 is used to provide this feedback information. Stored A/P and lateral images of the hip are displayed in windows 1602 and 1604. Representation 1606 of the femur is displayed and updated in real time. The position of the femoral component is known based on the position of the instrument selected to broach the femur. The broaching instrument, or “broach”, is tracked. The version, relative leg length and neck offset information, is shown in area 1608. The surgeon selects a head of the femoral component using a page such as the page 1700 shown in FIG. 17 based on the neck offset that is indicated. Each of the heads has a different offset length. The difference between the measured reference leg length and the current leg length is known based on the position of the fixed acetabular component, the position of the femoral component, the geometries of the acetabular and femoral component, which are known and stored by the program, and the relative positions of the pelvis and femur, as indicated by the trackable marker arrays attached to each. The version information is based on the orientation of the femoral component and the position of the trans-epicondylar axis on the femur, or other landmark that may be used to indicate version of the lower leg. This axis can be identified with respect to a lateral image of the knee taken during the planning process. Because the position of the femur is tracked, the CAS system will always know the coordinates of this axis.

As a final step, after insertion of both components of the artificial hip, the process at step 348 tracks the position of the femur as the surgeon moves it through a range of motion, and displays the range of motion of the femur with respect to the pelvis.

At the conclusion of the procedure, the surgeon is prompted to specify whether to archive data generated by the procedure for later reference. The CAS system archives the data as directed, such as to a disk drive or removable media.

If desired, the different steps discussed herein may be performed in any order and/or concurrently with each other. Furthermore, if desired, one or more of the above described steps may be optional or may be combined without departing from the scope of the present invention.

Embodiments of the present invention may be implemented in software, hardware, application logic or a combination of software, hardware and application logic. The software, application logic and/or hardware may reside on processor-based system 16 or on a removable storage medium. If desired, part of the software, application logic and/or hardware may reside on processor-based system 16 and part of the software, application logic and/or hardware may reside on the removable storage medium.

1. A computer based local navigation system, comprising,
a localizer;
a computer system in communication with the localizer for storing and executing instructions for performing the following process:
displaying in at least two screens corresponding to two or more steps of a hip-replacement procedure, at least one of the two or more screens requesting information on location of at least one anatomical landmark for defining a predetermined anatomical feature of a hip of a patient; and
displaying in the other of the at least two screens a position and an angle, relative to a predetermined the feature of the hip, of a surgical tool being tracked.
